(19) United States
(12) Patent Application Publication
(10) Pub. No.: US 2004/0069342 A1
(43) Pub. Date: Apr. 15, 2004

(54) Drag reduction of a heat-distributing water-based liquid contaning large amounts of anti-freeze

(76) Inventors: Martin Hellsten, Odasmal (SE); Hans Oskarsson, Stenungsund (SE)

Correspondence Address: Michelle J Burke, Akzo Nobel Inc, Intellectual Property Department, 7 Livingstone Avenue, Dobbs Ferry, NY, 10522-3408, US

(21) Appl. No.: 10/470,034

(22) PCT Filed: Jan. 15, 2002
(86) PCT No.: PCT/SE02/00058

(30) Foreign Application Priority Data
Jan. 23, 2001 (SE) 0100177-5

(51) Int. Cl. F17D 1/16

(52) U.S. Cl. 137/13

(57) ABSTRACT

The present invention relates to the use of a zwitterionic surfactant in combination with an anionic surfactant, selected from the group consisting of a sulphonate, a sulphate, an ether sulphate, an ether carboxylate, or a mixture thereof, as a drag-reducing agent in a water-based liquid suitable for heat distribution. Besides the drag-reducing agent the water-based liquid contains 5-35% by weight of the ethylene glycol compound of the formula HO(C2H4O)nH, where n is a number from 1 to 4 and 0-4% by weight of an electrolyte.

The present invention relates to the use of a zwitterionic surfactant in combination with an anionic surfactant as a drag reducing agent in a flowing heat-distributing water-based liquid containing 5-35% by weight of an ethylene glycol compound as an anti-freeze.

In recent years surfactants with the ability to form extremely long cylindric micelles have attracted a great interest as drag reducing agents in circulating water, eg for heat distribution. Thus, the U.S. Pat. No. 5,902,784 discloses a method for reducing the drag in a flowing water-based liquid by adding at least one betaine surfactant having a saturated or unsaturated alkyl or acyl group of 10-24 carbon atoms and at least one anionic surfactant having the formula

R₁-B

where R₁ is a hydrocarbon group of 10-24 carbon atoms and B is the group

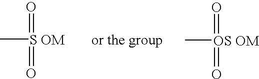

where M is hydrogen or a cationic group. In addition the patent also mentions that the water-based liquid may contain components such as rust-preventing agents, anti-freeze and bactericides.

When pumping hot, water-based liquids in long conduits in the cold temperated or polaric zones it is an impending fact that the liquid will freeze if the flow is interrupted for a longer time. To prevent freezing, large amounts of anti-freeze may be added but such an amount is expected to have a negative effect on the ability of the drag reducing agent to form micelles and thereby also the ability of the agent to reduce drag.

It has been found that these problems are solved by a water-based liquid containing a composition of surfactants as a drag-reducing agent and an ethylene glycol compound as an anti-freeze. Said water-based liquid is characterised by containing

a) 0.01-1.0% by weight of a surfactant composition containing a zwitterionic surfactant having the formula

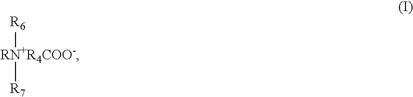

R is a group containing a saturated or unsaturated hydrocarbon group or acyl group with 20-24 carbon atoms, R₆ and R₇ are independently of each other an alkyl group of 1-4 carbon atoms or an hydroxyalkyl group of 2-4 carbon atoms and R₄ is an alkylene group of 1-4 carbon atoms, preferably CH₂ or a group

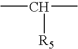

where R₅ is an alkyl group of 1-3 carbon atoms,

and 0-140%, suitably 5-140%, by weight of the zwitterionic surfactant of formula I of another zwitterionic surfactant having the formula

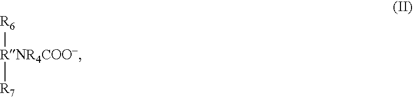

where R″ is a group containing a saturated or unsaturated hydrocarbon group or acyl group with 10-19 carbon atoms and R₆, R₇ and R₄ have the meanings mentioned above,

in combination with an anionic surfactant having the general structure

R₁(OA)ₙB, R₁O(AO)ₙCₘH₂ₘD, R₃NH(AO)ₙCₘH₂ₘD or R₁E

or a mixture thereof, where R₁ is a hydrocarbon group of 10-24 carbon atoms, R₃ is an acyl group of 10-24 carbon atoms, A is an alkylene group having 2-4 carbon atoms, n is a number from 1 to 10, m is a number from 1 to 4, B is a sulphate group OSO₃M, D is a carboxylate group COOM, E is a sulphate group OSO₃M or a sulphonate group —SO₃M and M is a cationic, preferably monovalent group,

in a weight proportion between the total amount of the zwitterionic surfactants of formula I and II and the total amount of the anionic surfactants from 100:1 to 1:2, preferably from 50:1 to 2:1,

b) 5-35%, preferably 10-30%, by weight of a glycol compound of the formula HO(C₂H₄O)ₙH, where n is 1-4, preferably 1,

c) 65-95%, preferably 70-90%, by weight of water and

d) 0-4%, preferably 0.005-1%, by weight of an inorganic, water-soluble electrolyte.

The drag-reducing effect of the surfactant composition is excellent over a large temperature range despite the large amount of the ethylene glycol compound in the liquid. The drag-reducing effect is also improved by the presence of the electrolyte, especially when the liquid also contains zwitterionic surfactants of formula II.

The total amount of the zwitterionic surfactants and the anionic surfactants may vary within wide limits depending on the conditions but is generally 0.1-10 kg/m³ of the water-based system. The water-based liquid according to the invention is especially suited for use in long conduits for heat distributions in cold temperated or polaric zones and can be pumped at temperatures below −10° C. and yet exhibits a good drag reducing effect within a wide temperature range suitable for heat transfer.

The group R in the zwitterionic surfactant is suitably an aliphatic group having 20-24 carbon atoms or a group R′NHC₃H₆, where R′ designates an acyl group having 20-24 carbon atoms. Preferably the zwitterionic surfactant has the general formula

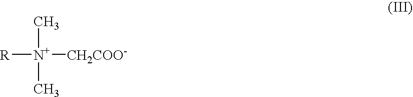

where R is an aliphatic group having 20-24 carbon atoms or the group R′NHC₃H₆, where R′ is an acyl group having 20-24 is carbon atoms. In an embodiment of the invention the zwitterionic compound containing an aliphatic or acyl group of 20-24 carbon atoms can be supplemented with a zwitterionic surfactant of formula II of the same structure containing preferably a hydrocarbon or acyl group having only 12-19 carbon atoms. This zwitterionic surfactant has preferably the formula

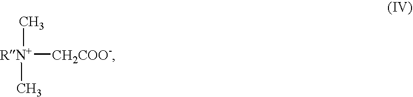

where R″ is an aliphatic group of 12-19 carbon atoms or the group R′″NHC₃H₆, where R′″ is an acyl group of 12-19 carbon atoms. The amount of these supplementary zwitterionic surfactants can preferably be from 5% to 100% by weight of the necessary zwitterionic surfactants of formula I.

The hydrophobic group R₁ of the anionic surfactant can be aliphatic or aromatic, straight or branched, saturated or unsaturated and contains suitably 12-18 carbon atoms. The acyl group R₃ can be straight or branched, saturated or unsaturated and contains suitably 12-18 carbon atoms. Normally the alkylene groups A are ethylene, n is preferably a number from 1-5, CₘH₂ₘ is preferably methylene but can also be the group

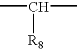

where R₈ is an alkyl group having 1-3 carbon atoms, and M is preferably sodium and potassium.

The above described zwitterionic surfactants may be produced by well-known methods, e.g. by reacting a compound of the formula

RNR₆R₇ or R″NR₆R₇

where R, R″, R₆ and R₇ have the meanings mentioned above, and a compound of the formula

HalR₄COONa

where R₄ has the meaning mentioned above and Hal, where Hal is Cl or Br, at a pH-value of about 9.5 in a medium of a lower alcohol and water. To obtain a good drag reducing effect it is essential that the amount of the amine reactant in the zwitterionic product used is low. If a low halide content in the product is desirable the reaction can preferably be made in isopropanol with the lowest water content possible, whereby the sodium halide formed in the reaction will crystallize out of the product and may be removed by filtration or centrifugation. Another route to a halide-free product is to quaternize the amine reactant with ethylene oxide and an acid catalyst and then dehydrogenate the resulting product to the desired zwitterionic surfactant.

The anionic surfactants for use in accordance with the present invention are well-known and so are also the methods for their production. Suitable examples are alkali salts of decyl sulphate, dodecyl sulphate, tetradecyl sulphate, hexadecyl sulphate, octadecyl sulphate, oleyl sulphate, eicosyl sulphate, docosyl sulphate, rape seed alkyl sulphate, tallow alkyl sulphate and nonylphenyl sulphate and the corresponding ether sulphates and carboxymethyl ethers with 1, 2 or 3 ethyleneoxy units. Other suitable anionic surfactants are decanoic acid, dodecanoic, tetradecanoic, hexadecanoic, octadecanoic and oleic acid amide carboxymethyl ethers with 1, 2 or 3 ethyleneoxy units. Still other suitable anionic surfactants are alkali salts of decyl sulphonate, dodecyl sulphonate, tetradecyl sulphonate, hexadecyl sulphonate, oleyl sulphonate, dodecylbenzene sulphonate and hexadecylbenzene sulphonate.

The electrolyte, which does not include the zwitterionic or anionic surfactants of the present invention, can be any salt, alkali or acid soluble in water. Suitable examples are Na₂SO₄, K₂SO₄, (NH₃)₂SO₄, NaNO₂, NaNO₃, NaCl, Ca(OH)₂, CaCO₃, Ca(HCO₃)₂, Mg(OH)₂, Mg(HCO₃)₂, Na₂CO₃, Na₃PO₄, Na₂HPO₄, (NH₃)₃PO₄, (NH₃)₂HPO₄, sodium citrate and sodium formate. In the electrolyte content, the salt causing the water hardness has also to be included. Thus Ca(HCO₃)₂ causing a water hardness of 1° dH shall be calculated as the presence of 29 ppm of electrolyte. The need of the electrolyte increases with increasing amount of the zwitterionic and anionic surfactants having a hydrocarbon group or an acyl group of less than 20 carbon atoms and decreases with decreasing amount of the glycol. The glycol compound is preferably a monoethylene glycol, since this compound has a larger freezing point reduction than the other glycol compounds, such as diethylene glycol.

The choice of the zwitterionic surfactant and the anionic surfactant will depend on the temperature of the water-based system. At higher temperature the number of carbon atoms in mainly R, R′, R₁ and R₂ will normally be higher than at lower temperatures. For example, a suitable mixture of surfactants contains N-behenyl betaine combined with dodecylbenzene sulphonate or a C₁₂-C₁₈ saturated or unsaturated alkyl ether sulphate. In the preparation of the water-based liquid a dry mixture or a liquid concentrate containing for example 2-30% by weight of the zwitterionic and anionic surfactants in desired ratios may advantageously be used. Solvents, such as isopropanol, ethylene glycol compounds, e.g. monoethylene glycol, water or mixtures thereof can be used to solubilize the surfactants.

A convenient way to determine the right proportion between the zwitterionic surfactant and the anionic surfactant for a certain type of water is to make up a solution of e.g. 2.0 kg/m³ of the zwitterionic surfactant in the desired contents of the glycol and the appropriate water in a 50 ml glass beaker with a magnetic stirrer and keep the temperature in the middle of the intended temperature range for the system. This solution is then titrated with e.g. a solution of the anionic surfactant with a concentration of 10 kg/m³ in the desired contents of the glycol and the appropriate water until the originally formed vortex has disappeared.

Apart from the zwitterionic and anionic surfactants, the water-based system may contain a number of conventional components such as corrosion inhibitors and bactericides.

The present invention will now be further illustrated with the aid of the following examples.

### EXAMPLE 1

The drag of aqueous liquids containing mixtures of surfactants was determined in accordance with the beaker test described above. During the test an aqueous liquid, containing 80% by weight of water at 3°dH, 20% by weight of monoethylene glycol and minor amounts of surfactants in accordance with Table I below, was stirred at a constant rotation speed of 700 r/min. The absence of a vortex or a vortex of maximum 2 mm was equal with drag reducing ability. The following results were obtained.

TABLE I

| | | Na dodecyl- | |
|---|---|---|---|
| N-behenyl | N-stearyl | benzene | Interval with |
| betaine | betaine | sulphonate | low drag |
| ppm | ppm | ppm | ° C. |
| 1575 | 175 | 0 | No effect |
| 1575 | 175 | 35 | 40-68 |
| 1575 | 175 | 52 | 40-70 |
| 1575 | 175 | 70 | 40-73 |
| 1575 | 175 | 87 | 39-74 |
| 1575 | 175 | 122 | 39-77 |
| 1575 | 175 | 157 | 39-80 |
| 1575 | 175 | 192 | 39-74 |
| 1400 | 350 | 87 | 33-65 |

The results show that a drag reducing agent containing N-behenyl betaine and N-stearyl betaine in combination with sodium dodecylbenzene sulphonate has a good drag reducing effect in an aqueous liquid containing a large amount of monoethylene glycol.

### EXAMPLE 2

In the same manner as in Example 1 the drag of aqueous liquids, containing 1350 ppm of N-behenyl betaine, 1350 ppm of N-stearyl betaine, anionic surfactants in varying amounts, 83% by weight deionized water, 17% by weight of monoethylene glycol and electrolytes in accordance with Table II below, was determined. The pH-values of the liquids were adjusted to 9-10 by addition of ammonia.

The following results were obtained. The amounts of the anionic surfactants are given as ppm within brackets.

TABLE II

| | Interval with 1 w drag, ° C. | | |
|---|---|---|---|
| Anionic | Deionized | NaNO₂ | Na₂SO₄ |
| surfactant | water | g/l | g/l |
| Sodium dodecyl | No effect | 32-62 (950) | 32-64 (950) |
| sulphate | | 1.6 | 1.6 |
| Sodium dodecyl- | No effect | 25-63 (300) | 32-63 (500) |
| (EO)₃-sulphate | | 1.6 | 1.6 |
| Sodium dodecylbenzene | No effect | 26-74 (300) | 25-70 (300) |
| sulphonate | | 1 | 1 |

From the results it is evident that the presence of the electrolytes NaNO₂ and Na₂SO₄ was essential to obtain a good drag reducing effect.

### EXAMPLE 3

In the same manner as in Example 1 the drag of aqueous liquids, containing 2000 ppm of N-behenyl betaine, 20% by weight of mono ethylene glycol, and various amounts of electrolytes and anionic surfactants and electrolytes in accordance with the Table III below, was determined at a constant rotation speed of 700 r/min or 1000 r/min. The pH-values of the liquids were adjusted to about 9-10 by addition of ammonia. The following results were obtained. The amount of the anionic surfactants are given as ppm within brackets.

TABLE III

| Aqueous | | Interval with low drag, ° C. | |
|---|---|---|---|
| liquid | Addition | 700 r/min | 1000 r/min |
| 1 | Sodium dodecyl-(EO)₃- | 53-70 (40) | No effect |
| | sulphate | | |
| | Deionized water | | |
| 2 | Sodium dodecyl-(EO)₃- | 44-82 (60) | 50-79 (60) |
| | sulphate | | |
| | Deionized water | | |
| | 0.5 g/l NaNO₂ | | |
| 3 | Sodium dodecylbenzene | 45-82 (30) | 61-70 (30) |
| | sulphonate | | |
| | Deionized water | | |
| 4 | Sodium dodecylbenzene | 44-92 (100) | 46-87 (100) |
| | sulphonate | | |
| | Deionized water | | |
| | 0.5 g/l NaNO₂ | | |
| 5 | Sodium dodecylbenzene | Not tested | 50-80 (30) |
| | sulphonate | | |
| | Water 3.8 ° dH | | |

From the results it is evident that the presence of electrolytes in the liquids increases the temperature range with reduced drag.

1. A water-based liquid, characterised in that it contains
a) 0.01-1.0% by weight of a surfactant composition containing a zwitterionic surfactant having the formula 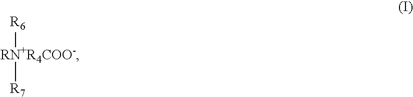
R is a group containing a saturated or unsaturated hydrocarbon group or acyl group with 20-24 carbon atoms, R₆ and R₇ are independently of each other an alkyl group of 1-4 carbon atoms or an hydroxyalkyl group of 2-4 carbon atoms, M is a cationic group, and R₄ is an alkylene group of 1-4 carbon atoms,
and 0-140% by weight of the zwitterionic surfactant of formula I of another zwitterionic surfactant having the formula 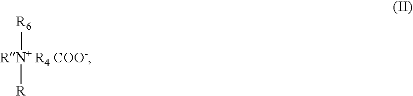
where R″ is a group containing a saturated or unsaturated hydrocarbon group or acyl group with 10-19 carbon atoms and R₆, R₇ and R₄ have the meanings mentioned above,
in combination with an anionic surfactant having the general structure
R₁(OA)ₙB, R₁O(AO)ₙCₘH₂ₘD, R₃NH(AO)ₙCₘH₂ₘD or R₁E
or a mixture thereof, where R₁ is a hydrocarbon group of 10-24 carbon atoms, R₃ is an acyl group of 10-24 carbon atoms, A is an alkylene group having 2-4 carbon atoms, n is a number from 1 to 10, m is a number from 1 to 4, B is a sulphate group OSO₃M, D is a carboxylate group COOM, E is a sulphate group OSO₃M or a sulphonate group —SO₃M and M is a cationic group,
in a weight proportion between the total amount of the zwitterionic surfactants of formula I and II and the total amount of the anionic surfactants of from 100:1 to 1:2,
b) 5-35% by weight of a glycol compound of the formula HO(C₂H₄O)ₙH, where n is 1-4, preferably 1,
c) 65-95% by weight of water and
d) 0-4% by weight of an inorganic, water-soluble electrolyte.

2. A water-based liquid, according to claim 1, characterised in that the zwitterionic surfactant of formula I has the formula 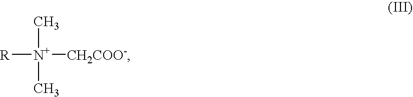
where R is an aliphatic group of 20-24 carbon atoms or a group R′NHC₃H₆, where R′ is an acyl group of 20-24 carbon atoms.

3. A water-based liquid according to claim 1 or 2, characterised in that the zwitterionic surfactant of formula II has the formula 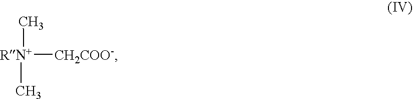
where, R″ is an aliphatic group of 12-19 carbon atoms or a group R′″NHC₃H₆, where R′″ is an acyl group of 12-19 carbon atoms.

4. A water-based liquid according to any one of claims 1-3, characterised in that the zwitterionic surfactant of formula II is present in an amount of 5-140% by weight of the zwitterionic surfactant of formula I.

5. A water-based liquid according to any one of claims 1-4, characterised in that in the anionic surfactants the designation CₘH₂ₘ is methylene, A is ethylene and n is 1-5.

6. A water-based liquid according to any one of claims 1-5, characterised in that the electrolyte is present in an amount of 0.005 to 1.0% by weight.

7. Use of a surfactant composition containing a zwitterionic surfactant having the formula 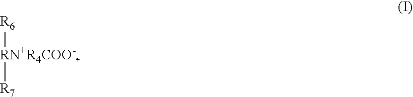
R is a group containing a saturated or unsaturated hydrocarbon group or acyl group with 20-24 carbon atoms, R₆ and R₇ are independently of each other an alkyl group of 1-4 carbon atoms or an hydroxyalkyl group of 2-4 carbon atoms and R₄ is an alkylene group of 1-4 carbon atoms,
and 0-140% by weight of the zwitterionic surfactant of formula I of another zwitterionic surfactant having the formula 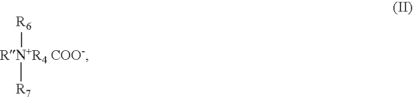
where R″ is a group containing a saturated or unsaturated hydrocarbon group or acyl group with 10-19 carbon atoms and R₆, R₇ and R₄ have the meanings mentioned above,
in combination with an anionic surfactant having the general structure
R₁(OA)ₙB, R₁O(AO)ₙCₘH₂ₘD, R₃NH(AO)ₙCₘH₂ₘD or R₁E
or a mixture thereof, where R₁ is a hydrocarbon group of 10-24 carbon atoms, R₃ is an acyl group of 10-24 carbon atoms, A is an alkylene group having 2-4 carbon atoms, n is a number from 1 to 10, where m is 1-4, B is a sulphate group OSO₃M, D is a carboxylate group COOM, E is a sulphate group OSO₃M or a sulphonate group —SO₃M and M is a cationic group,
in a weight proportion between the total amount of the zwitterionic surfactants of formula I and II and the total amount of the anionic surfactants of from 100:1 to 1:2,
as a drag-reducing agent in a water-based liquid containing
b) 5-35% by weight of a glycol compound of the formula HO(C₂H₄O)ₙH, where n is 1-4,
c) 65-95% by weight of water and
d) 0-4% by weight of an inorganic, water-soluble electrolyte.

8. Use according to claim 7, where the zwitterionic surfactant of formula I has the formula 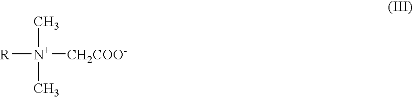
where R is an aliphatic group of 20-24 carbon atoms or a group R′NHC₃H₆, where R′ is an acyl group of 20-24 carbon atoms.

9. Use according to claim 7 or 8, where the zwitterionic surfactant of formula II has the formula 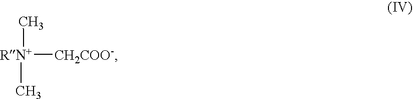
where, R″ is an aliphatic group of 12-19 carbon atoms or a group R′″NHC₃H₆, where R′″ is an acyl group of 12-19 carbon atoms, and is present in an amount of 5-140% by weight of the zwitterionic surfactant of formula I.

10. A surfactant composition containing a zwitterionic surfactant having the formula 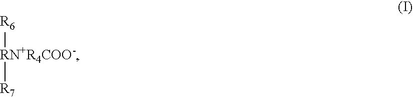
R is a group containing a saturated or unsaturated hydrocarbon group or acyl group with 20-24 carbon atoms, R₆ and R₇ are independently of each other an alkyl group of 1-4 carbon atoms or an hydroxyalkyl group of 2-4 carbon atoms and R₄ is an alkylene group of 1-4 carbon atoms,
and 5-140% by weight of the zwitterionic surfactant of formula I of another zwitterionic surfactant having the formula 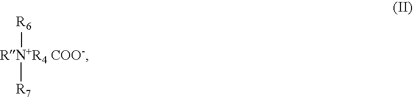
where R″ is a group containing a saturated or unsaturated hydrocarbon group or acyl group with 10-19 carbon atoms and R₆, R₇ and R₄ have the meanings mentioned above,
in combination with an anionic surfactant having the general structure
R₁(OA)ₙB, R₁O(AO)ₙCₘH₂ₘD, R₃NH(AO)ₙCₘH₂ₘD or R₁E
or a mixture thereof, where R₁ is a hydrocarbon group of 10-24 carbon atoms, R₃ is an acyl group of 10-24 carbon atoms, A is an alkylene group having 2-4 carbon atoms, n is a number from 1 to 10, m is a number from 1 to 4, B is a sulphate group OSO₃M, D is a carboxylate group COOM, E is a sulphate group OSO₃M or a sulphonate group —SO₃M and M is a cationic group,
in a weight proportion between the total amount of the zwitterionic surfactants of formula I and II and the total amount of the anionic surfactants of from 100:1 to 1:2.
